(19) United States
(12) Patent Application Publication
(10) Pub. No.: US 2024/0320120 A1
(43) Pub. Date: Sep. 26, 2024

(54) TEST EQUIPMENT FAILURE IDENTIFICATION SYSTEMS AND METHODS

(71) Applicant: Future Dial, Inc., Sunnyvale, CA (US)

(72) Inventors: Angel Michelle Anderson, Spencer, IN (US); Hongshan Zhang, Cupertino, CA (US)

(21) Appl. No.: 18/186,459

(22) Filed: Mar. 20, 2023

(51) Int. Cl. G06F 11/34; G06F 11/07

(52) U.S. Cl. CPC G06F 11/3409; G06F 11/0706; G06F 2201/81

(57) ABSTRACT

A system includes a device-under-test and a first computing device. A first of a plurality of communication ports of the first computing device is configured to be connected in electronic communication with the communication port of the first device-under-test. A processor of the first computing device is configured to monitor a status of a test performed on the first device-under-test. In response to a value of a counter associated with the first of the plurality of communication ports of the first computing device being greater than a threshold, the display device of the first computing device displays an indicator that a consecutive number of failures is greater than the threshold.

### FIELD OF THE TECHNOLOGY

At least some embodiments disclosed herein relate generally to equipment failures. More specifically, at least some embodiments relate to monitoring a status of a device under test to identify an equipment failure.

### BACKGROUND

Computing devices can be returned and refurbished for resale. It is important that a refurbished device pass a variety of tests to confirm the refurbished device is acceptable for resale. It is possible for faulty equipment used in the testing process can cause failures of the device under test.

### BRIEF DESCRIPTION OF THE DRAWINGS

References are made to the accompanying drawings that form a part of this disclosure and illustrate embodiments in which systems and methods described in this Specification can be practiced.

FIG. 1 shows a test system, according to some embodiments.

FIG. 2 shows a test system, according to some embodiments.

FIG. 3 is a flowchart of a method, according to some embodiments.

FIG. 4 is a flowchart of a method, according to some embodiments.

FIG. 5 is a flowchart of a method, according to some embodiments.

FIG. 6 is a flowchart of a method, according to some embodiments.

FIG. 7 is a block diagram illustrating an internal architecture of an example of a computer, according to some embodiments.

Like reference numbers represent the same or similar parts throughout.

### DETAILED DESCRIPTION

Computing devices can be returned and refurbished for resale. It is important that a refurbished computing device pass a variety of tests to confirm the refurbished computing device is acceptable for resale (e.g., in good working condition). It is possible for faulty test equipment used in the testing process to cause failures of a device under test (e.g., a candidate computing device for refurbishment). Such “false-failures,” can be a result of the test equipment used in the testing process. For example, in some cases, a computing device executing the test on the device under test may need to be rebooted. In some cases, a port via which the computing device executing the test on the device under test may be starting to fail and causing inconsistent results. In some cases, the port via which the computing device executing the test on the device under test may have failed and be causing consistent failures. In some cases, a cable connecting the test equipment and the device under test may be starting to fail and causing inconsistent test results. In some cases, the cable connecting the test equipment and the device under test may have failed and be causing consistent failures. In all of these cases, the devices under test may be able to pass the variety of tests, and the false-failures could result in otherwise acceptable computing devices being marked as unacceptable.

Embodiments of this disclosure are directed to monitoring failure rates during testing of computing devices. The monitoring of the failure rates can be performed on a per port basis, a per test computing device basis, combination thereof, or the like. In some embodiments, in response to exceeding a threshold number of failures, an alert can automatically be provided to a user to resolve the issue. In some embodiments, the failure tracking can be stored and a report can be generated after execution of tests.

In some embodiments, the failure rate tracking can be selectively disabled by a test operator in case of, for example, testing devices with known problems (which may include a higher number of expected failures). In some embodiments, the failure rate tracking can be enabled by default, and selectively disabled by the operator. In some embodiments, the failure rate tracking can be disabled by default, and selectively enabled by the operator.

In some embodiments, the thresholds for acceptable failure rates can be modified over time.

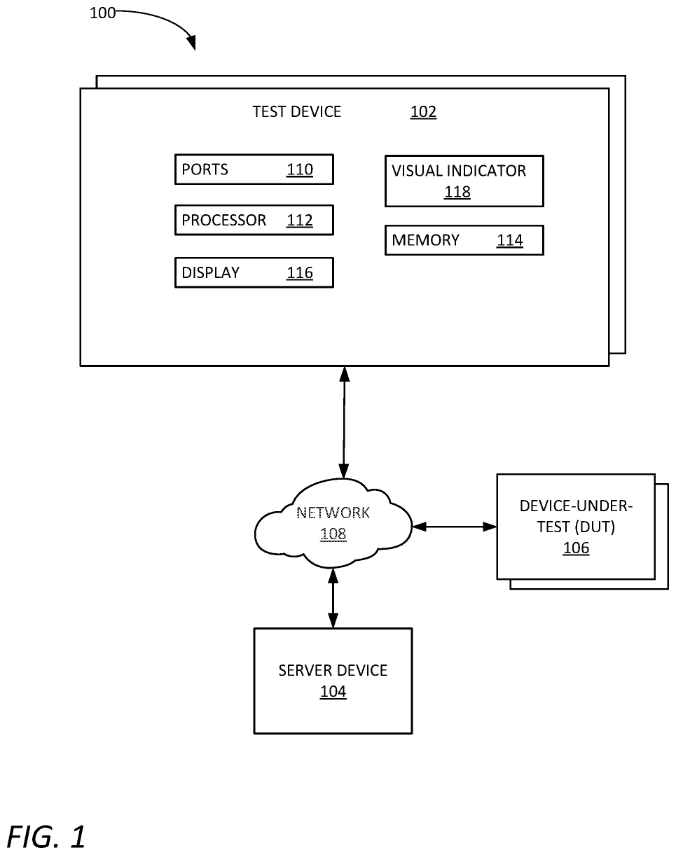

FIG. 1 shows a test system 100, according to some embodiments. The test system 100 can be used to, for example, run one or more diagnostic tests on a computing device (e.g., a device-under-test (DUT)) and can be configured to monitor a failure rate of the diagnostic tests to monitor and diagnose false failures.

In some embodiments, the test system 100 includes one or more test devices 102, a server 104, and one or more DUTs 106. In some embodiments, the one or more test devices 102 can be referred to as the test equipment, test computing device, a workstation, or the like. In some embodiments, the one or more DUTs 106 can be referred to as a computing device, mobile device, or the like.

The one or more test devices 102 can be connected in electronic communication with the server 104 and the one or more DUTs 106 via a network 108. In some embodiments, a plurality of one or more DUTs 106 are connected to one of the one or more test devices 102.

The one or more test devices 102 can each include a plurality of ports 110. The plurality of ports 110 can enable communication with the one or more DUTs 106. In some embodiments, the ports 110 can be communication ports such as, but not limited to, universal serial bus (USB) or the like. It is to be appreciated that the one or more test devices 102 and the one or more DUTs 106 can be connected via a wired connection or a wireless connection.

In some embodiments, the one or more test devices 102 includes a processor 112 and a memory 114. In some embodiments, the memory 114 can store a counter for each of the ports 110. In some embodiments, the counter can store a value corresponding to a number of failed tests for the corresponding one of the ports 110. In some embodiments, the failed test counter can be reset in response to a passed test. In some embodiments, the failed test counter can be reset upon initialization of an application for conducting tests using the one or more test devices 102. In some embodiments, the memory 114 can store a total test counter for each of the ports 110. The total test counter can store a value corresponding to the number of completed tests on each of the ports 110. In some embodiments, the total test counter can store a total number of tests (including passed and failed), a total number of failed tests, and a total number of passed tests. In some embodiments, the memory 114 can store a workstation counter for all tests conducted on the particular one or more test devices 102. For example, the workstation counter can include a completed number of tests for all ports on the particular one or more test devices 102, regardless of completion status. In some embodiments, the workstation counter can store a total number of tests (including passed and failed), a total number of failed tests, and a total number of passed tests.

In some embodiments, the different counters can be used to output an indicator to a display 116 of the one or more test devices 102. For example, when a number of failed tests on a particular port reaches a threshold value, the one or more test devices 102 can display an indicator on the display 116 showing the operator that one of the ports 110 has reached a threshold failure amount. In some embodiments, the indicator requires the operator to select to either disable the corresponding port or keep processing using that port. In some embodiments, the testing using the corresponding port is stopped until the operator takes an action. In some embodiments, the one or more test devices 102 may additionally have a visual indicator 118 such as, but not limited to, a light emitting diode (LED). In such embodiments, the visual indicator 118 can be configured to be enabled (or flashed on and off) until the operator makes a selection of whether to continue processing or disable the failing port.

In some embodiments, an operator may be able to disable the failure tracking on one of the ports 110. For example, if an operator is testing a batch of the one or more DUTs 106 that are expected to have a higher failure rate, then the operator can exclude the corresponding one of the ports 110 from the tracking. Such exclusion may be retained until the operator either restarts the testing application or the operator re-enables the tracking for the one of the ports 110.

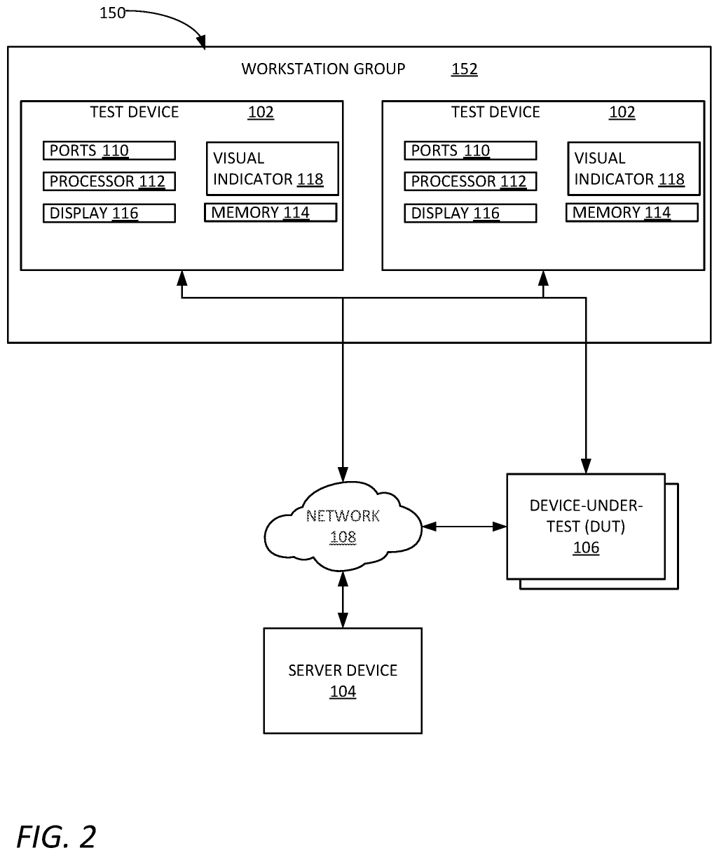

FIG. 2 shows a test system 150, according to some embodiments.

The test system 150 includes a plurality of test devices 102 grouped into a workstation group 152. There can be a plurality of workstation groups in the test system 150. Features of FIG. 1 that were already described are not described again with respect to FIG. 2 in additional detail unless express reference otherwise.

In the illustrated embodiment, the one or more test devices 102 can be grouped into the workstation group 152. The workstation group 152 can provide another layer of tracking for false failures. For example, the one or more test devices 102 can be grouped based on a location, a type of one or more DUTs 106 being tested, combinations thereof, or the like. As a result, the server 104 can obtain failure numbers for the one or more test devices 102 within the workstation group 152. The failure rates can be used to highlight which of the one or more test devices 102 may have a higher failure rate than others of the one or more test devices 102. This can, for example, be an indication that the particular one of the one or more test devices 102 is failing and needs to be replaced, needs to be restarted, or the like.

In some embodiments, the one or more test devices 102 can periodically (e.g., every 5, 10, 15, etc. minutes, every 1 hour, every 2 hours, etc.) report failure counts for each of the one or more test devices 102. In some embodiments, a minimum number of tests may be needed to have been completed before the server 104 provides an output to be displayed on one of the one or more test devices 102. In some embodiments, if the minimum number of tests has not been met, the server 104 can wait until the next period to complete the review and potential flagging. In some embodiments, if the minimum number of tests has not been met, the server 104 can adjust the time period and use additional data.

In some embodiments, a failure rate can be calculated by dividing a number of failed transactions by a number of total transactions (e.g., number of failed transactions/number of total transactions). In some embodiments, the failure rate may be acceptable if within a certain percentage of the average failure rate across all ports 110 or all one or more test devices 102 within the workstation group 152.

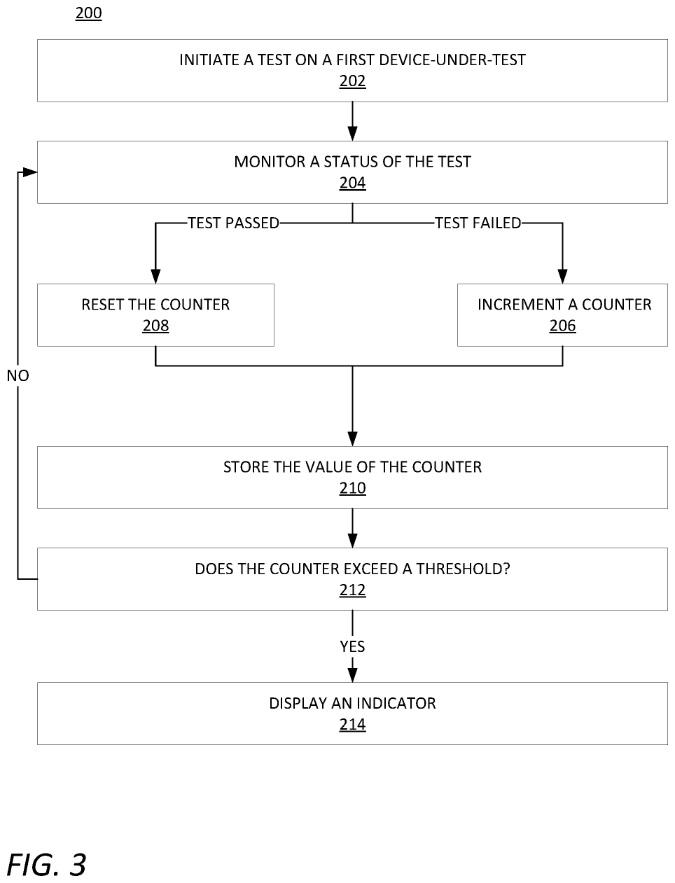

FIG. 3 is a flowchart of a method 200, according to some embodiments.

At block 202, the method 200 includes initiating, by a processor of a computing device (e.g., one of the one or more test devices 102 in FIG. 1 and FIG. 2), a test on a first device-under-test (e.g., the one or more DUTs 106 in FIG. 1 and FIG. 2) connected in electronic communication with the computing device. In some embodiments, the first device-under-test is connected in electronic communication with the computing device via a first of a plurality of communication ports.

At block 204, the method 200 includes monitoring, by the processor, a status of the test on the first device-under-test.

At block 206, the method 200 includes, in response to the monitoring indicating a failed test, incrementing a counter, wherein the counter indicates a total number of failures on the first of the plurality of communication ports.

At block 208, the method 200 includes, in response to the monitoring indicating a passed test, resetting the counter.

At block 210, the method 200 includes storing a value of the counter in the memory.

At block 212, the method 200 includes determining, whether the counter value exceeds a threshold.

At block 214, the method 200 includes displaying an indicator on a display (display 116 of FIG. 1 and FIG. 2) that indicates the first of the plurality of communication ports has exceeded a threshold number of failures. In some embodiments, in response to the indicator, the operator can disable the first of the plurality of communication ports or the operator can allow for the port to continue to be used.

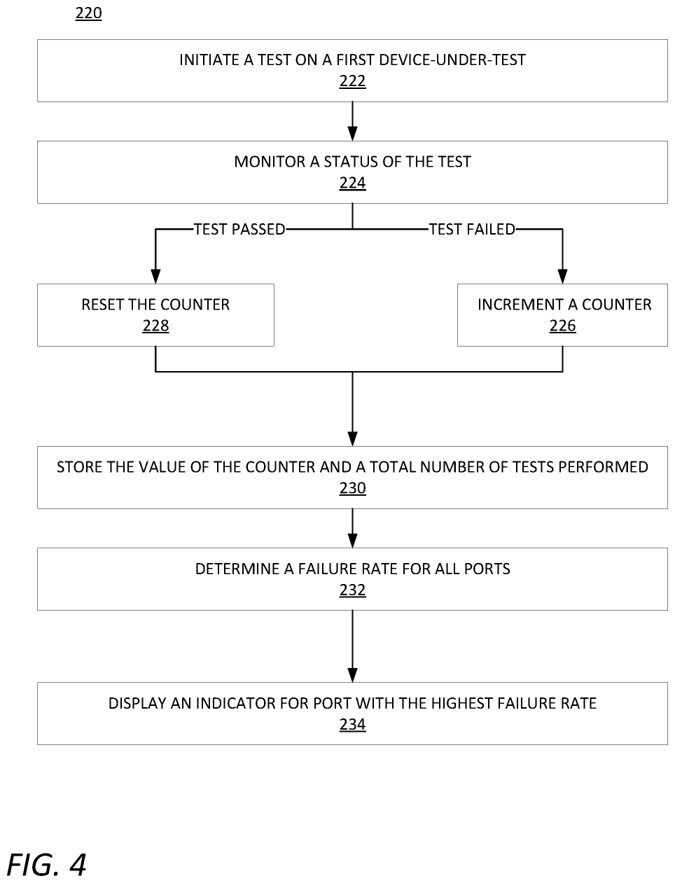

FIG. 4 is a flowchart of a method 220, according to some embodiments.

At block 222, the method 220 includes initiating, by a processor of a computing device (e.g., one of the one or more test devices 102 in FIG. 1 and FIG. 2), a test on one or more devices-under-test (e.g., the one or more DUTs 106 in FIG. 1 and FIG. 2) connected in electronic communication with the computing device. In some embodiments, the DUTs are connected in electronic communication with the computing device via a plurality of communication ports.

At block 224, the method 220 includes monitoring, by the processor, a status of the tests on the DUTs.

At block 226, the method 220 includes, in response to the monitoring indicating a failed test, incrementing a counter, wherein the counter indicates a total number of failures on a respective one of the plurality of communication ports.

At block 228, the method 220 includes, in response to the monitoring indicating a passed test, resetting the respective counter.

At block 230, the method 220 includes storing a value of the counters in the memory and storing a value of a total number of tests performed.

At block 232, the method 220 includes determining a failure rate of each of the plurality of communication ports.

At block 234, the method 220 includes displaying an indicator on a display (display 116 of FIG. 1 and FIG. 2) that indicates one of the plurality of communication ports has exceeded a failure rate of the others of the plurality of communication ports. In some embodiments, in response to the indicator, the operator can disable the one of the plurality of communication ports or the operator can allow for the communication port to continue to be used. In some embodiments, instead of being a comparative value across the communication ports, the indicator can be displayed if one of the plurality of communication ports has exceeded an average failure rate of the others of the plurality of communication ports. In some embodiments, the indicator can be displayed if one of the plurality of communication ports has exceeded a threshold failure rate. In some embodiments, the failure rate may be computed if there are a minimum number of tests having been executed. If not, the failure rate may be skipped and determined at a later time during execution of the test.

In some embodiments, blocks 232 and 234 can be performed on a periodic basis. For example, the period can be every 1 minute, 5 minutes, 10 minutes, 15 minutes, etc., every 1 hour, every 2 hours, etc.

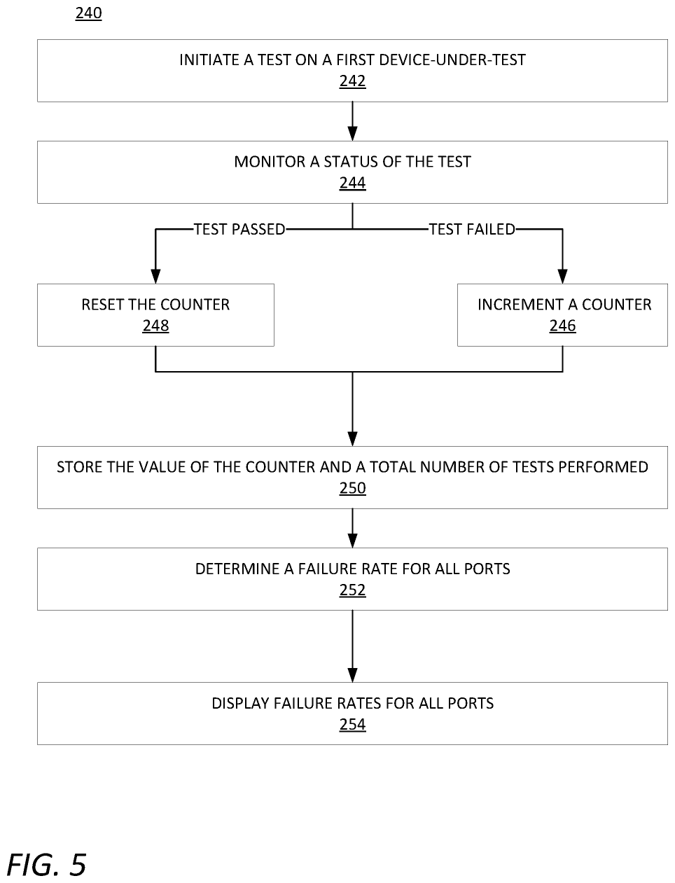

FIG. 5 is a flowchart of a method 240, according to some embodiments.

At block 242, the method 240 includes initiating, by a processor of a computing device (e.g., one of the one or more test devices 102 in FIG. 1 and FIG. 2), a test on one or more devices-under-test (e.g., the one or more DUTs 106 in FIG. 1 and FIG. 2) connected in electronic communication with the computing device. In some embodiments, the DUTs are connected in electronic communication with the computing device via a plurality of communication ports.

At block 244, the method 240 includes monitoring, by the processor, a status of the tests on the DUTs.

At block 246, the method 240 includes, in response to the monitoring indicating a failed test, incrementing a counter, wherein the counter indicates a total number of failures on a respective one of the plurality of communication ports.

At block 248, the method 240 includes, in response to the monitoring indicating a passed test, resetting the respective counter.

At block 250, the method 240 includes storing a value of the counters in the memory and storing a value of a total number of tests performed.

At block 252, the method 240 includes determining a failure rate of each of the plurality of communication ports.

At block 254, the method 220 includes displaying an indicator on a display (display 116 of FIG. 1 and FIG. 2) that indicates the failure rate for each of the plurality of communication ports. In some embodiments, in response to the indicator, the operator can disable the one of the plurality of communication ports or the operator can allow for the communication port to continue to be used. In some embodiments, the failure rate may be computed if there are a minimum number of tests having been executed. If not, the failure rate may be skipped and determined at a later time during execution of the test.

In some embodiments, blocks 252 and 254 can be performed on a periodic basis. For example, the period can be every 1 minute, 5 minutes, 10 minutes, 15 minutes, etc., every 1 hour, every 2 hours, etc.

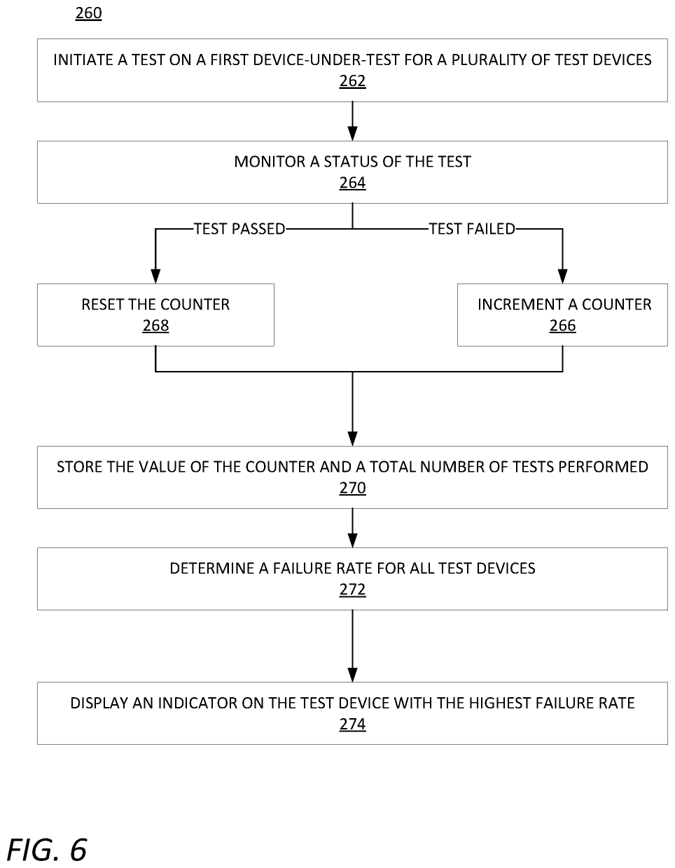

FIG. 6 is a flowchart of a method 260, according to some embodiments.

At block 262, the method 260 includes initiating, by a processor of a computing device (e.g., one of the one or more test devices 102 in FIG. 1 and FIG. 2), a test on one or more devices-under-test (e.g., the one or more DUTs 106 in FIG. 1 and FIG. 2) connected in electronic communication with the computing device. In some embodiments, the DUTs are connected in electronic communication with the computing device via a plurality of communication ports. In some embodiments, the computing device is one of a plurality of computing devices grouped together.

At block 264, the method 260 includes monitoring, by the processor, a status of the tests on the DUTs on each of the plurality of computing devices.

At block 266, the method 260 includes, in response to the monitoring indicating a failed test, incrementing a counter, wherein the counter indicates a total number of failures on a respective one of the plurality of communication ports.

At block 268, the method 260 includes, in response to the monitoring indicating a passed test, resetting the respective counter.

At block 270, the method 260 includes storing a value of the counters in the memory and storing a value of a total number of tests performed.

At block 272, the method 260 includes determining a failure rate of each of the plurality of computing devices.

At block 274, the method 260 includes displaying an indicator on a display (display 116 of FIG. 1 and FIG. 2) that indicates the failure rate for the respective computing device is greater than the failure rate for others of the plurality of computing devices. In some embodiments, in response to the indicator, the operator can select to continue processing using the respective computing device or select to restart the application or the computing device.

In some embodiments, blocks 272 and 274 can be performed on a periodic basis. For example, the period can be every 1 minute, 5 minutes, 10 minutes, 15 minutes, etc., every 1 hour, every 2 hours, etc.

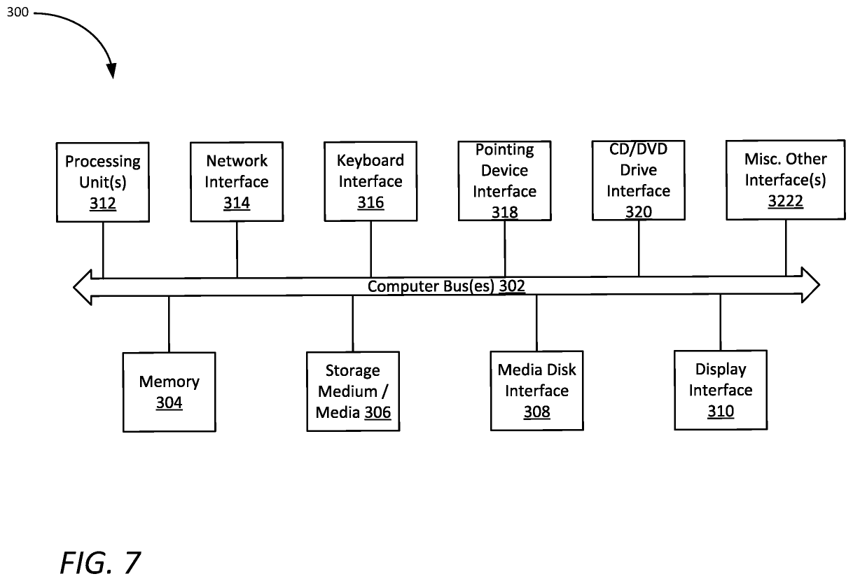

FIG. 7 is a block diagram illustrating an internal architecture 300 of an example of a computer, such as the one or more test devices 102 (FIG. 1; FIG. 2), the server 104 (FIG. 1; FIG. 2), or the one or more DUTs 106 (FIG. 1; FIG. 2), according to some embodiments. A computing device as referred to herein refers to any device with a processor capable of executing logic or coded instructions, and could be a server, personal computer, set top box, smart phone, pad computer or media device, to name a few such devices. As shown in the example of FIG. 5, internal architecture 300 includes one or more processing units (also referred to herein as CPUs) 280, which interface with at least one computer bus 302. Also interfacing with computer bus 302 are persistent storage medium/media 306, network interface 314, memory 304, e.g., random access memory (RAM), run-time transient memory, read only memory (ROM), etc., media disk drive interface 308 as an interface for a drive that can read and/or write to media including removable media such as floppy, CD ROM, DVD, etc. media, display interface 310 as interface for a monitor or other display device, keyboard interface 316 as interface for a keyboard, pointing device interface 318 as an interface for a mouse or other pointing device, CD/DVD drive interface 320, and miscellaneous other interfaces 322 not shown individually, such as parallel and serial port interfaces, a universal serial bus (USB) interface, and the like.

Memory 304 interfaces with computer bus 302 so as to provide information stored in memory 304 to CPU 312 during execution of software programs such as an operating system, application programs, device drivers, and software modules that comprise program code, and/or computer executable process operations, incorporating functionality described herein, e.g., one or more of process flows described herein. CPU 312 first loads computer executable process operations from storage, e.g., memory 304, storage medium/media 306, removable media drive, and/or other storage device. CPU 312 can then execute the stored process operations in order to execute the loaded computer-executable process operations. Stored data, e.g., data stored by a storage device, can be accessed by CPU 312 during the execution of computer-executable process operations.

Persistent storage medium/media 306 is a computer readable storage medium(s) that can be used to store software and data, e.g., an operating system and one or more application programs. Persistent storage medium/media 306 can also be used to store device drivers, such as one or more of a digital camera driver, monitor driver, printer driver, scanner driver, or other device drivers, web pages, content files, playlists and other files. Persistent storage medium/media 306 can further include program modules and data files used to implement one or more embodiments of the present disclosure.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Examples of non-transitory computer-readable storage media include, but are not limited to, any tangible medium capable of storing a computer program for use by a programmable processing device to perform functions described herein by operating on input data and generating an output. A computer program is a set of instructions that can be used, directly or indirectly, in a computer system to perform a certain function or determine a certain result. Examples of non-transitory computer-readable storage media include, but are not limited to, a floppy disk; a hard disk; a random access memory (RAM); a read-only memory (ROM); a semiconductor memory device such as, but not limited to, an erasable programmable read-only memory (EPROM), an electrically erasable programmable read-only memory (EEPROM), Flash memory, or the like; a portable compact disk read-only memory (CD-ROM); an optical storage device; a magnetic storage device; other similar device; or suitable combinations of the foregoing.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

In some embodiments, a system including: a first device-under-test including a communication port; and a first computing device including: a processor; a memory; a display device; and a plurality of communication ports; wherein a first of the plurality of communication ports of the first computing device is configured to be connected in electronic communication with the communication port of the first device-under-test; wherein the processor of the first computing device is configured to: monitor a status of a test performed on the first device-under-test; in response to the status indicating a failed test, increment a counter associated with the first of the plurality of communication ports of the first computing device indicating a total number of failures on the first of the plurality of communication ports of the first computing device; in response to the status indicating a passed test, reset the counter associated with the first of the plurality of communication ports of the first computing device; store a value of the counter associated with the first of the plurality of communication ports of the first computing device in the memory of the first computing device; and in response to the value of the counter associated with the first of the plurality of communication ports of the first computing device being greater than a threshold, cause the display device of the first computing device to display an indicator that a consecutive number of failures is greater than the threshold; in response to the value of the counter being less than the threshold, continue to monitor the status of the test performed on the device-under-test.

In some embodiments, a system, further including: a second device-under-test having a communication port; wherein a second of the plurality of communication ports of the first computing device is configured to be connected in electronic communication with the communication port of the second device-under-test; wherein the processor of the first computing device is configured to: monitor a status of a test performed on the second device-under-test; in response to the status indicating a failed test, increment a counter associated with the second of the plurality of communication ports of the first computing device indicating a total number of failures on the second of the plurality of communication ports of the first computing device; in response to the status indicating a passed test, reset the counter associated with the second of the plurality of communication ports of the first computing device; store a value of the counter associated with the second of the plurality of communication ports of the first computing device in the memory of the first computing device; and in response to the value of the counter associated with the second of the plurality of communication ports of the first computing device being greater than a threshold, cause the display device of the first computing device to display an indicator that a consecutive number of failures is greater than the threshold; in response to the value of the counter being less than the threshold, continue to monitor the status of the test performed on the device-under-test.

In some embodiments, a system, further including: a third device-under-test having a communication port; wherein the first of the plurality of communication ports of the first computing device is configured to be connected in electronic communication with the communication port of the third device-under-test after disconnection of the first device-under-test; wherein the processor of the first computing device is configured to: monitor a status of a test performed on the third device-under-test; in response to the status indicating a failed test, increment a counter associated with the first of the plurality of communication ports of the first computing device indicating a total number of failures on the first of the plurality of communication ports of the first computing device; in response to the status indicating a passed test, reset the counter associated with the first of the plurality of communication ports of the first computing device; store a value of the counter associated with the first of the plurality of communication ports of the first computing device in the memory of the first computing device; and in response to the value of the counter associated with the first of the plurality of communication ports of the first computing device being greater than a threshold, cause the display device of the first computing device to display an indicator that a consecutive number of failures is greater than the threshold; in response to the value of the counter being less than the threshold, continue to monitor the status of the test performed on the device-under-test.

In some embodiments, a system, wherein the processor of the first computing device is configured to periodically compute a first failure percentage of the first of the plurality of communication ports and a second failure percentage of the second of the plurality of communication ports; and wherein the processor of the first computing device is configured to cause the display device of the first computing device to display an indicator that one of the first failure percentage or the second failure percentage is higher than the other of the first failure percentage or the second failure percentage.

In some embodiments, a system, further including: a second device-under-test having a communication port; a second computing device including: a processor; a memory; a display device; and a plurality of communication ports; wherein a first of the plurality of communication ports of the second computing device is configured to be connected in electronic communication with the communication port of the second device-under-test; wherein the processor of the second computing device is configured to: monitor a status of a test performed on the second device-under-test; in response to the status indicating a failed test, increment a counter associated with the first of the plurality of communication ports of the second computing device indicating a total number of failures on the first of the plurality of communication ports of the second computing device; in response to the status indicating a passed test, reset the counter associated with the first of the plurality of communication ports of the second computing device; store a value of the counter associated with the first of the plurality of communication ports of the second computing device in the memory of the second computing device; and in response to the value of the counter associated with the first of the plurality of communication ports of the second computing device being greater than a threshold, cause the display device of the second computing device to display an indicator that a consecutive number of failures is greater than the threshold; in response to the value of the counter being less than the threshold, continue to monitor the status of the test performed on the second device-under-test.

In some embodiments, a system, wherein the first computing device and the second computing device are in a first group of computing devices.

In some embodiments, a system, wherein the first computing device is configured to receive an indication to disable port monitoring.

In some embodiments, a system, wherein the first computing device further includes a light indicator, the light indicator configured to be enabled in response to the indicator being displayed on the display device.

In some embodiments, a system, further including a server device, wherein the first computing device is connected in electronic communication with the server device, wherein the first computing device is configured to output a report to the server device.

In some embodiments, a system, wherein the first computing device is configured to periodically determine the counter for each of the plurality of communication ports.

In some embodiments, a system, wherein in response to a restart of the first computing device, the monitoring is enabled.

In some embodiments, a method, including: initiating, by a processor of a first computing device, a test on a first device-under-test connected in electronic communication with the first computing device, wherein the first device-under-test is connected in electronic communication with the first computing device via a first of a plurality of communication ports; monitoring, by the processor, a status of the test on the first device-under-test; in response to the monitoring indicating a failed test, incrementing a counter, wherein the counter indicates a total number of failures on the first of the plurality of communication ports; in response to the monitoring indicating a passed test, resetting the counter; storing a value of the counter in a memory of the first computing device.

In some embodiments, a method, further including: comparing, by the processor, the counter to a threshold; and in response to the value of the counter being greater than a threshold, displaying, on a display device of the first computing device, an indicator that a consecutive number of failures is greater than the threshold; in response to the value of the counter being less than the threshold, monitoring the status of the test performed on the first device-under-test.

In some embodiments, a method, further including: determining, by the processor, a total number of failed tests executed on the first of the plurality of communication ports; determining, by the processor, a value of a total number of tests executed on the first of the plurality of communication ports; in response to the total of number of tests exceeding a threshold, determining, by the processor, a failure percentage based on the total number of failed tests and the total number of tests; storing the failure percentage for the first of the plurality of communication ports in the memory of the first computing device.

In some embodiments, a method, further including: initiating, by the processor of the first computing device, a test on a second device-under-test connected in electronic communication with the second computing device, wherein the second device-under-test is connected in electronic communication with the first computing device via a second of a plurality of communication ports; monitoring, by the processor, a status of the test on the second device-under-test; in response to the monitoring indicating a failed test, incrementing a counter, wherein the counter indicates a total number of failures on the second of the plurality of communication ports; in response to the monitoring indicating a passed test, resetting the counter; storing a value of the counter in the memory of the first computing device.

In some embodiments, a method, further including: determining a total number of failed tests executed on the second of the plurality of communication ports; determining a value of a total number of tests executed on the second of the plurality of communication ports; in response to the total of number of tests exceeding a threshold, determining a failure percentage based on the total number of failed tests and the total number of tests; storing the failure percentage for the second of the plurality of communication ports in the memory of the first computing device.

In some embodiments, a method, further including: comparing the failure percentage for the first of the plurality of communication ports and the failure percentage for the second of the plurality of communication ports; and in response to the first of the plurality of communication ports having a higher failure percentage than the second of the plurality of communication ports, displaying, on a display device of the first computing device, an indicator that the first of the plurality of communication ports is failing at a higher rate than the second of the plurality of communication ports.

In some embodiments, a method, further including: initiating, by a processor of a second computing device, a test on a second device-under-test connected in electronic communication with the second computing device, wherein the second device-under-test is connected in electronic communication with the second computing device via a first of a plurality of communication ports of the second computing device; monitoring, by the processor, a status of the test on the second device-under-test; in response to the monitoring indicating a failed test, incrementing a counter, wherein the counter indicates a total number of failures on the first of the plurality of communication ports of the second computing device; in response to the monitoring indicating a passed test, resetting the counter; storing a value of the counter in a memory of the second computing device.

In some embodiments, a non-transitory computer-readable storage medium including instructions that, when executed by a processor, cause the processor to perform a method, including: initiating, by a processor of a computing device, a test on a first device-under-test connected in electronic communication with the computing device, wherein the first device-under-test is connected in electronic communication with the computing device via a first of a plurality of communication ports; monitoring, by the processor, a status of the test on the first device-under-test; in response to the monitoring indicating a failed test, incrementing a counter, wherein the counter indicates a total number of failures on the first of the plurality of communication ports; in response to the monitoring indicating a passed test, resetting the counter; storing a value of the counter in a memory of the computing device.

In some embodiments, a non-transitory computer-readable storage medium, the method further including: comparing the counter to a threshold; and in response to the value of the counter being greater than a threshold, displaying, on a display device, an indicator that a consecutive number of failures is greater than the threshold; in response to the value of the counter being less than the threshold, monitoring the status of the test performed on the device-under-test.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

The terminology used herein is intended to describe embodiments and is not intended to be limiting. The terms “a,” “an,” and “the” include the plural forms as well, unless clearly indicated otherwise. The terms “comprises” and/or “comprising,” when used in this Specification, specify the presence of the stated features, integers, steps, operations, elements, and/or components, but do not preclude the presence or addition of one or more other features, integers, steps, operations, elements, and/or components.

What is claimed is:

1. A system comprising:
a first device-under-test comprising a communication port; and
a first computing device comprising:
a processor;
a memory;
a display device; and
a plurality of communication ports;
wherein a first of the plurality of communication ports of the first computing device is configured to be connected in electronic communication with the communication port of the first device-under-test;
wherein the processor of the first computing device is configured to:
monitor a status of a test performed on the first device-under-test;
in response to the status indicating a failed test, increment a counter associated with the first of the plurality of communication ports of the first computing device indicating a total number of failures on the first of the plurality of communication ports of the first computing device;
in response to the status indicating a passed test, reset the counter associated with the first of the plurality of communication ports of the first computing device;
store a value of the counter associated with the first of the plurality of communication ports of the first computing device in the memory of the first computing device; and
in response to the value of the counter associated with the first of the plurality of communication ports of the first computing device being greater than a threshold, cause the display device of the first computing device to display an indicator that a consecutive number of failures is greater than the threshold;
in response to the value of the counter being less than the threshold, continue to monitor the status of the test performed on the device-under-test.

2. The system of claim 1, further comprising:
a second device-under-test having a communication port;
wherein a second of the plurality of communication ports of the first computing device is configured to be connected in electronic communication with the communication port of the second device-under-test;
wherein the processor of the first computing device is configured to:
monitor a status of a test performed on the second device-under-test;
in response to the status indicating a failed test, increment a counter associated with the second of the plurality of communication ports of the first computing device indicating a total number of failures on the second of the plurality of communication ports of the first computing device;
in response to the status indicating a passed test, reset the counter associated with the second of the plurality of communication ports of the first computing device;
store a value of the counter associated with the second of the plurality of communication ports of the first computing device in the memory of the first computing device; and
in response to the value of the counter associated with the second of the plurality of communication ports of the first computing device being greater than a threshold, cause the display device of the first computing device to display an indicator that a consecutive number of failures is greater than the threshold;
in response to the value of the counter being less than the threshold, continue to monitor the status of the test performed on the device-under-test.

3. The system of claim 2, further comprising:
a third device-under-test having a communication port;
wherein the first of the plurality of communication ports of the first computing device is configured to be connected in electronic communication with the communication port of the third device-under-test after disconnection of the first device-under-test;
wherein the processor of the first computing device is configured to:
monitor a status of a test performed on the third device-under-test;
in response to the status indicating a failed test, increment a counter associated with the first of the plurality of communication ports of the first computing device indicating a total number of failures on the first of the plurality of communication ports of the first computing device;
in response to the status indicating a passed test, reset the counter associated with the first of the plurality of communication ports of the first computing device;
store a value of the counter associated with the first of the plurality of communication ports of the first computing device in the memory of the first computing device; and
in response to the value of the counter associated with the first of the plurality of communication ports of the first computing device being greater than a threshold, cause the display device of the first computing device to display an indicator that a consecutive number of failures is greater than the threshold;
in response to the value of the counter being less than the threshold, continue to monitor the status of the test performed on the device-under-test.

4. The system of claim 3, wherein the processor of the first computing device is configured to periodically compute a first failure percentage of the first of the plurality of communication ports and a second failure percentage of the second of the plurality of communication ports; and wherein the processor of the first computing device is configured to cause the display device of the first computing device to display an indicator that one of the first failure percentage or the second failure percentage is higher than the other of the first failure percentage or the second failure percentage.

5. The system of claim 1, further comprising:
a second device-under-test having a communication port;
a second computing device comprising:
a processor;
a memory;
a display device; and
a plurality of communication ports;
wherein a first of the plurality of communication ports of the second computing device is configured to be connected in electronic communication with the communication port of the second device-under-test;
wherein the processor of the second computing device is configured to:
monitor a status of a test performed on the second device-under-test;
in response to the status indicating a failed test, increment a counter associated with the first of the plurality of communication ports of the second computing device indicating a total number of failures on the first of the plurality of communication ports of the second computing device;
in response to the status indicating a passed test, reset the counter associated with the first of the plurality of communication ports of the second computing device;
store a value of the counter associated with the first of the plurality of communication ports of the second computing device in the memory of the second computing device; and
in response to the value of the counter associated with the first of the plurality of communication ports of the second computing device being greater than a threshold, cause the display device of the second computing device to display an indicator that a consecutive number of failures is greater than the threshold;
in response to the value of the counter being less than the threshold, continue to monitor the status of the test performed on the second device-under-test.

6. The system of claim 5, wherein the first computing device and the second computing device are in a first group of computing devices.

7. The system of claim 1, wherein the first computing device is configured to receive an indication to disable port monitoring.

8. The system of claim 1, wherein the first computing device further comprises a light indicator, the light indicator configured to be enabled in response to the indicator being displayed on the display device.

9. The system of claim 1, further comprising a server device, wherein the first computing device is connected in electronic communication with the server device, wherein the first computing device is configured to output a report to the server device.

10. The system of claim 1, wherein the first computing device is configured to periodically determine the counter for each of the plurality of communication ports.

11. The system of claim 1, wherein in response to a restart of the first computing device, the monitoring is enabled.

12. A method, comprising:
initiating, by a processor of a first computing device, a test on a first device-under-test connected in electronic communication with the first computing device, wherein the first device-under-test is connected in electronic communication with the first computing device via a first of a plurality of communication ports;
monitoring, by the processor, a status of the test on the first device-under-test;
in response to the monitoring indicating a failed test, incrementing a counter, wherein the counter indicates a total number of failures on the first of the plurality of communication ports;
in response to the monitoring indicating a passed test, resetting the counter;
storing a value of the counter in a memory of the first computing device.

13. The method of claim 12, further comprising:
comparing, by the processor, the counter to a threshold; and
in response to the value of the counter being greater than a threshold, displaying, on a display device of the first computing device, an indicator that a consecutive number of failures is greater than the threshold;
in response to the value of the counter being less than the threshold, monitoring the status of the test performed on the first device-under-test.

14. The method of claim 12, further comprising:
determining, by the processor, a total number of failed tests executed on the first of the plurality of communication ports;
determining, by the processor, a value of a total number of tests executed on the first of the plurality of communication ports;
in response to the total of number of tests exceeding a threshold, determining, by the processor, a failure percentage based on the total number of failed tests and the total number of tests;
storing the failure percentage for the first of the plurality of communication ports in the memory of the first computing device.

15. The method of claim 14, further comprising:
initiating, by the processor of the first computing device, a test on a second device-under-test connected in electronic communication with the second computing device, wherein the second device-under-test is connected in electronic communication with the first computing device via a second of a plurality of communication ports;
monitoring, by the processor, a status of the test on the second device-under-test;
in response to the monitoring indicating a failed test, incrementing a counter, wherein the counter indicates a total number of failures on the second of the plurality of communication ports;
in response to the monitoring indicating a passed test, resetting the counter;
storing a value of the counter in the memory of the first computing device.

16. The method of claim 15, further comprising:
determining a total number of failed tests executed on the second of the plurality of communication ports;
determining a value of a total number of tests executed on the second of the plurality of communication ports;
in response to the total of number of tests exceeding a threshold, determining a failure percentage based on the total number of failed tests and the total number of tests;
storing the failure percentage for the second of the plurality of communication ports in the memory of the first computing device.

17. The method of claim 16, further comprising:
comparing the failure percentage for the first of the plurality of communication ports and the failure percentage for the second of the plurality of communication ports; and
in response to the first of the plurality of communication ports having a higher failure percentage than the second of the plurality of communication ports, displaying, on a display device of the first computing device, an indicator that the first of the plurality of communication ports is failing at a higher rate than the second of the plurality of communication ports.

18. The method of claim 12, further comprising:
initiating, by a processor of a second computing device, a test on a second device-under-test connected in electronic communication with the second computing device, wherein the second device-under-test is connected in electronic communication with the second computing device via a first of a plurality of communication ports of the second computing device;
monitoring, by the processor, a status of the test on the second device-under-test;
in response to the monitoring indicating a failed test, incrementing a counter, wherein the counter indicates a total number of failures on the first of the plurality of communication ports of the second computing device;
in response to the monitoring indicating a passed test, resetting the counter;
storing a value of the counter in a memory of the second computing device.

19. A non-transitory computer-readable storage medium comprising instructions that, when executed by a processor, cause the processor to perform a method, comprising:
initiating, by a processor of a computing device, a test on a first device-under-test connected in electronic communication with the computing device, wherein the first device-under-test is connected in electronic communication with the computing device via a first of a plurality of communication ports;
monitoring, by the processor, a status of the test on the first device-under-test;
in response to the monitoring indicating a failed test, incrementing a counter, wherein the counter indicates a total number of failures on the first of the plurality of communication ports;
in response to the monitoring indicating a passed test, resetting the counter;
storing a value of the counter in a memory of the computing device.

20. The non-transitory computer-readable storage medium of claim 19, the method further comprising:
comparing the counter to a threshold; and
in response to the value of the counter being greater than a threshold, displaying, on a display device, an indicator that a consecutive number of failures is greater than the threshold;
in response to the value of the counter being less than the threshold, monitoring the status of the test performed on the device-under-test.
